(19) United States
(12) Patent Application Publication
(10) Pub. No.: US 2002/0049852 A1
(43) Pub. Date: Apr. 25, 2002

(54) Global messaging with distributed adaptive streaming control

(76) Inventors: Yen-Jen Lee, Fremont, CA (US); Chiun-An Chao, Hsin-Chu City (TW); Ray Ngai, Santa Clara, CA (US); Ming-Chao Chiang, San Jose, CA (US); Yu-Ping Huang, Sam-chumg (TW)

Correspondence Address: SKJERVEN MORRILL MACPHERSON LLP, THREE EMBARCADERO CENTER, 28TH FLOOR, SAN FRANCISCO, CA, 94111, US

(21) Appl. No.: 09/729,637

(22) Filed: Dec. 1, 2000

Related U.S. Application Data
(60) Provisional application No. 60/169,111, filed on Dec. 6, 1999.

(51) Int. Cl. G06F 15/16

(52) U.S. Cl. 709/231

(57) ABSTRACT

A software implementable approach capable of creating, delivering, reassembling, rendering, and storing asynchronous and synchronous multimedia message. This approach integrates video/audio streaming with existing Internet/Intranet e-mail messaging and video/audio conferencing systems. The software provides both one-way asynchronous communication as well as bi-directional synchronous communication. Each stream represents a user access from client on one computer to server on the other computer. The method enables electronic multimedia messaging on video/audio capture-equipped mobile platform with limited pre-installed software capability or memory footprint.

### CROSS REFERENCE TO RELATED APPLICATIONS

This application claims priority from U.S. provisional patent application Ser. No. 60/169,111, entitled “Internet Real Time Video Caster”, filed Dec. 6, 1999.

The above referenced application is incorporated herein by reference for all purposes. The prior application, in some parts, may indicate earlier efforts at describing the invention or describing specific embodiments and examples. The present invention is, therefore, best understood as described herein.

### FIELD OF THE INVENTION

The invention is related generally to messaging of continuous media through a computer network and, more particularly, to communicating audio and video messages via the Internet.

Copyright Notice

A portion of the disclosure of this patent document may contain materials that are subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Many applications exist for communicating video messages through a computer network. Systems for video messaging and their associated software programs must be able to perform a variety of functions. These include converting images into a network-communicable format and converting network-communicated image data into displayed images. Other control and management tasks must also be performed, such as management of video data files, coordination of participants to two-way video conferences and so forth. Accordingly, software applications used to implement such functions in video messaging systems tend to be complicated. As such, they tend to be time-consuming to create, de-bug and modify. They may also be difficult to use. Therefore, what is needed is a technique for avoiding or, at least, minimizing, such drawbacks.

An amount of bandwidth available for communicating a video message in a network, such as the Internet, may vary depending upon the status of the network. For example, during a period of high demand placed on the network, the available bandwidth may be reduced. Conventionally, assuming a video clip is to be communicated via the network in real-time for immediate viewing, the available network bandwidth may be insufficient. In which case, the communication must be postponed until sufficient bandwidth becomes available. Similarly, the time required to communicate a video clip for storage and later viewing (e.g., other than real-time viewing) may exceed the time available, depending upon the circumstances. Therefore, what is needed is an improved technique for communicating video messages in a network, particularly, the Internet, which does not suffer from the aforementioned drawbacks.

A typical example of video message communication is by an attachment to an electronic mail (e-mail) message. More particularly, a video clip is stored as a data file that is then sent by a sender to a recipient via an e-mail system by the sender attaching the video clip to an e-mail message. Once the e-mail message and attachment have been received and stored by the recipient, the video clip may be viewed. Video clips tend to require significantly more memory to store and more bandwidth to communicate than do typical textual e-mail messages. By sending the video clip as an attachment to the e-mail message, the video clip must be stored and communicated by the e-mail system along with textual message content. E-mail systems, however, often do not have storage and bandwidth capacity for sending attachments beyond certain size or have limitations placed on the size of attachments. When such a size limit is exceeded, the e-mail system typically strips off the offending attachment. A drawback to this approach, therefore, is that the video clip may not be delivered to the recipient as intended by the sender. Therefore, what is needed is an improved technique for communicating video messages in a network, particularly, the Internet, which does not suffer from the aforementioned drawback.

It is to these ends and deficiencies that the present invention is directed.

### SUMMARY OF THE INVENTION

The invention is a method and apparatus for communicating continuous media, such as video messages and, optionally, accompanying audio, over a network. The network may be a local area network or intranet. Alternately, the network may be a global network, such as the Internet (i.e. the World Wide Web).

In one aspect, a technique is provided in which various video messaging functions of a video messaging system are provided by modular computer software, while each module performs a specific task relating to video messaging. Invocation of appropriate combinations of the modules allow the system to perform a variety of video messaging functions, such as originating and sending a video message, browsing and viewing a stored video message, publishing a message including video content, conducting a two-way video conference, and receiving video messages, such as advertisements, when a computer system is otherwise idle. By providing the aforementioned functionality with appropriate combinations of application program modules, creation, debugging and modification of the application program modules and the system is simplified. However, functionality is not compromised.

In a particular aspect, a method and apparatus for communicating video messages is provided in which a general purpose computer system includes a memory for storage of application program modules, a camera for receiving video images and a display for display of video images. The application program modules include: a video capturing module for forming a stream of video data from images received by the camera; a video rendering module for rendering video images to the display from a stream of video data; a media publishing module for delivering video image data to a network; and a media manager module for control of video data files.

The application program modules are selectively invoked by a user selecting video messaging functions. Appropriate ones of the application program modules may be invoked based upon the selected video messaging function. The application program modules may be selectively invoked by a user selecting a video messaging function via a graphic user interface provided by a program control module. For example, when the user desires to create and send a video message, the user may select a function of publishing a video message. In response, the video capturing module and the media publishing module may be invoked for performing the selected function. As another example, the user may select a function of browsing available video data files and displaying a selected video data file. In response, the media manager module and the video rendering module may be invoked for performing the selected function. Note that the available video data files may be stored at a location remote from the general purpose computer system. In which case, the media manager module allows the user to remotely browse the files. The remote location may be in a web server accessible by the media manager module via a network, such as the Internet. Alternately, the available video data files may be stored at a location local to the general purpose computer system. In which case, the media manager allows the user to browse the local files.

The application program modules may also include a video telephone module for control of the video messaging system for two-way video sessions. The user may select a function of conducting a two-way video session. In response, the video telephone module may be invoked for performing the selected function. The video capturing module and the video rendering module may also be invoked for performing the selected two-way conferencing function.

The application program modules may also include an unattended streaming module for providing video images to the display at times when the computer system is otherwise idle. The video images provided by the unattended streaming module may be advertisements, news items or a combination thereof. The general subject matter of video images may be specified by the user. Alternately, video images may be targeted based upon the user's profile.

In another aspect, a method and apparatus for controlling a general purpose computer for delivering a video message to a remote server via a network is provided in which available bandwidth between the general purpose computer and the remote server is determined; a connection with the remote server is made; and the video message is sent to the remote server in accordance with the available bandwidth. The available bandwidth may be determined by sending a network packet on a round-trip between the general purpose computer and the remote server; and statistics associated the round-trip may be gathered. Sending of the message in accordance with the available bandwidth may include compressing the video message so as to require less bandwidth than otherwise.

Sending of the video message may be interrupted prior to completion of sending the entire video message to the remote server, in which case the remote server may perform a step of ignoring a received portion of the video message. Sending may be attempted again after a time delay.

In a further aspect, a method and apparatus for delivering a video, or other continuous media, message to a recipient is provided in which a video message is originated; and the video message is sent to a location in a server, indicia of the location of the message (e.g., its URL) is attached to the electronic mail message and the electronic mail message is sent to the recipient along with the attached indicia. The sender simultaneously initiates sending the video message and sending the electronic mail message. Accordingly, the sender need not perform extra steps associated with sending both the e-mail message and the video message separately. Thus, sending of the video message to the server is essentially transparent to the user. In addition, the entire video message need not be sent through the electronic mail system, as in the prior techniques. Rather, only the indicia (e.g., URL) need be included with the e-mail message. This avoids problems, such as stripping off of the attachment, associated with sending the video clip through the e-mail system as an attachment.

In yet another aspect, a method and apparatus for delivering a video message from a sender to a recipient is provided in which a video message is originated; and an electronic mail message is delivered to the recipient. The electronic mail message may be delivered by selecting between two delivery techniques. In the first technique, the video message is attached to the electronic mail message and the electronic mail message is send to the recipient along with the attached video message (i.e., the video message may optionally be sent as an attachment). In the second technique, the video message is sent to a location in a remote server, indicia of the location of the message (e.g., its URL) is attached to the electronic mail message and the electronic mail message is sent to the recipient along with the attached indicia. In the second technique, the sender simultaneously initiates sending the video message and sending the electronic mail message., Accordingly, the sender need not perform steps associated with sending both messages, nor must the entire video message to send through the electronic mail system. The second technique avoids problems associated with sending the message as an attachment.

The remote server may be a web server and the attached indicia being a uniform resource locator (URL). The electronic mail message may be received by the recipient; the remote server may be accessed when the video message is sent to the location in the remote server; and the video message may be viewed while the message is transferred to the recipient (i.e. the video message may be viewed in real-time). The video message may be displayed at a web page in format provided by a predefined template. Alternately, the video message may be transferred to the recipient's computer prior to viewing by the recipient.

### BRIEF DESCRIPTION OF THE DRAWINGS

FIG. 1 shows an embodiment of the streaming video messaging system architecture.

FIG. 2 is a flow chart for creating and publishing streaming a multimedia message.

FIG. 3 is a flow chart of browsing and rendering streaming multimedia messages.

FIG. 4 depicts a application design using the scalable navigation control manager.

FIG. 5 shows the procedures in an embodiment of the scalable navigation control manager.

FIG. 6 shows the operating procedures of the universal audio/video capturing manager.

FIG. 7 shows the operating procedures of the universal audio/video rendering manager.

FIG. 8 is a flowchart for the streaming media publishing manager.

FIG. 9 is a flowchart for the distributed streaming media manager.

FIG. 10 is a flowchart for the video phone control manager.

FIG. 11 is a flowchart of procedures of unattended streaming advertisement manager.

FIG. 12 is a block diagram showing a representative example logic device in which aspects of the present invention may be embodied.

The invention and various specific aspects and embodiments will be better understood with reference to the drawings and detailed descriptions. In the different figures, similarly numbered items are intended to represent similar functions within the scope of the teachings provided herein.

### DESCRIPTION OF THE PREFERRED EMBODIMENTS

Although the media delivery system described below is described mainly in terms of video streaming signals, those skilled in the art can appreciate that the description can be equally be applied to other continuous media, such as audio streaming signals, combined audio and video, or multimedia signals. It can also be applied to non-continuous media where the amount of data being transmitted for a single media data title is, although not continuous, very large. An example is the transmission of an image, for example a high-resolution X-ray, where the amount of data may be of sufficient size that it is more practical to transmit the particular media data title broken up into blocks as is done for the continuous case. The detailed description of the present invention here provides numerous specific details in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Previous work related to this patent can be categorized into several different classes. Video mail has been considered, for example, in U.S. Pat. No. 5,912,697 of S. Hashimoto et al., which developed a transmission system able to transmit large quantity of video/audio data. The approach of the present invention not only can utilize standard Internet streaming protocol to transmit large quantity of video/audio, but also provides an integrated messaging system for e-mail, web publishing, and both up and down streaming.

Conference recording is considered in U.S. Pat. No. 5,978,835 of L. F. Ludwig, et al., which developed a conference recording system which can store and forward a multimedia mail. The present approach described below can use both on-line and off-line creation to generate video/audio message and does not require a conferencing session to record video/audio message. In addition, the present approach can attach a video mail in a standard Internet e-mail message as commonly seen, but also can directly stream the video/audio object to a streaming media server for remote playback.

A media synchronization model is presented in G. Blakowski and R. Steinmetz, “A Media Synchronization Survey: Reference Model, Specification, and Case Studies”, IEEE Journal on Selected Areas in Communications, Vol. 14, No. 1, pp. 5-35, January 1996, which provides a comprehensive survey on researches in media synchronization. They propose a four-layer synchronization reference model. From the lower layer to the upper layer are Media Layer, Stream Layer, Object Layer, and Specification Layer. A variety of techniques have been published and implemented in the specification area. SMIL is one of the latest efforts in the industry to provide a presentation specification using descriptive tagged language which follows the syntax of XML. SMIL and XML are respectively described more fully in “Synchronized Multimedia Integration Language (SMWL)”, 1.0 Specification, WWW Consortium, June 1998, available via http://www.w3.org/TR/REC-smil and “Extensible Markup Language (XML)”, 1.0 Specification, WWW Consortium, February 1998, available via http://www.w3.org/TR/1998/REC-xml-19980210, both of which are hereby incorporated herein by this reference. The present approach incorporates part of the aforementioned works in specifying the relationship among continuous media (audio/video/animation) and none continuous media (text/graphics).

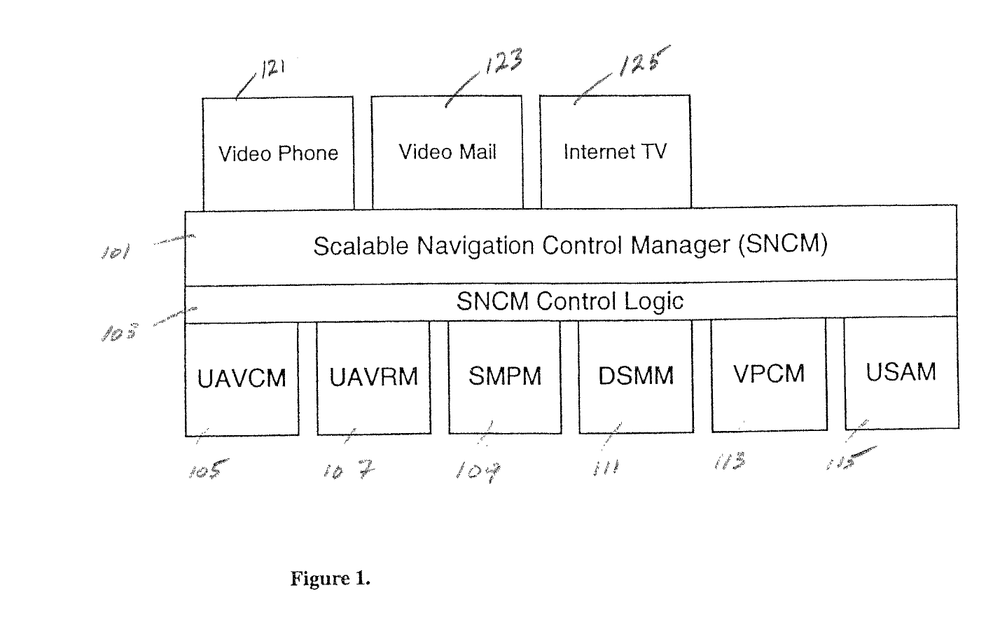

The streaming video messaging system architecture of the present invention is an application on a user's device and is shown schematically in FIG. 1. The details of the designs are elaborated in later sections. The various embodiments may include the modules described below.

The Scalable Navigation Control Manager (SNCM) 101 provides a virtual software turnkey solution framework. It is a layer of software “switches” in the control logic 103 to interface with both user interface and the other system components such as are shown attached below in this embodiment. Not all of these various managers 105-115 need to be included and can be replaced or augmented by additional units not shown. It mimics the user experience in consumer-type appliance. For instance, it can provide instant “switch-on” and “switch-over” features similar to an alarm radio clock. Within the layer is the logic to control the assembly of the other application and system software components to “switch-on” the desirable feature presented in the user interface. The feature can subsequently be torn down and “switch-over” to some other feature. The streaming application being developed on top of the scalable navigation control may include Video Mail 123, Video Phone (video conferencing) 121, Internet TV 125, Internet Phone (audio conferencing), Internet Boom Box, Internet Jukebox, Internet Radio, Internet DVD, Internet Screen Saver, and so on.

Universal Audio/Video Capturing Manager (UAVCM) 105 provides a real-time adaptive compressed or uncompressed video/audio stream to the other application or system components, which require or utilize the video/audio data. This manager works with generic audio/video capture device (or audio/video media file) and/or software audio/video compressors to form a pipeline of input and output stream of data. The output stream quality is adaptive to the source generating device and platform, e.g., CPU speed, available runtime memory, and available CODECs (coder-decoders). It can also transcode and/or synthesize the audio/video from one format to another format for proper handling and/or editing.

Universal Audio/Video Rendering Manager (UAVRM) 107 provides real-time audio/video display rendering to sound output device and/or video display device. It is capable of displaying both local media file on the same platform or streaming media from remote server over the networks. The manager examines a combination of media header and media object name to determine the sequence of operation to “build” a dynamic real-time decompression and/or pixel map rendering process.

The Streaming Media Publishing Manager (SMPM) 109 provides an integrated media stream uploading, e-mail messaging, and/or web publishing services, where publishing means the posting of the material at a web site as a web page. It leaves to the application to decide the combination of these services for its specific use. The media stream uploading service let application to create an audio/video or rich media data stream to a streaming media server. There is an implicit adaptive rate control scheme to prevent burst of data being remotely written to the server and to conserve the bandwidth usage over the Internet or low-bandwidth environment. It provides a mechanism for both client and server to maximize interactive use of respective systems. The MIME enabled e-mail messaging service provides both generic video/audio MIME attachment to go with the e-mail message. The messaging service can also generate URL within the message for WWW-like playback access for streaming audio/video. The web publishing service uses pre-defined templates to create and upload web pages to any web server that supports standard web publishing mechanisms. Within the web page, it may include all of the e-mail header information as well as message body that contains streaming audio/video playback component and information.

Distributed Streaming Media Manager (DSMM) 111 is a media and-network-aware object management subsystem. It is designed to provide transparent file-like management for local and remote media objects/files. These objects/files may contain either time-critical or non-time-critical data, and may reside on streaming media servers, file servers, or local storage. The subsystem is designed to handle customized object/file type through a plug-in application programmer's interface (API). Hence, applications developed on top of the subsystem can utilize coherent management API for object-specific management functionality.

The Video Phone Control Manager (VPCM) 113 provides both point-to-point video or audio conferencing as well as allowing the user to join a multi-point conferencing recording session. Coupled with Universal Audi/Video Rendering Manager 107, the video phone control manager can not only handle real-time synchronous conferencing, but also asynchronous review of recorded conferencing session from either conference record-relay servers or streaming media servers.

The system may also include an Unattended Streaming Advertisement Manager (USAM) 115 to provide unattended advertisement based on preconfigured settings or personal preference. It can utilize system idle time or become a screen saver to access streaming advertisement content in a distributed environment. It redefines the full-motion advertisement typically seen on TV for the desktop or mobile computing device.

It is well known in the art that logic or digital systems and/or methods can include a wide variety of different components and different functions in a modular fashion. The following will be apparent to those of skill in the art from the teachings provided herein. Different embodiments of the present invention can include different combinations of elements and/or functions. Different embodiments of the present invention can include actions or steps performed in a different order than described in any specific example herein. Different embodiments of the present invention can include groupings of parts or components into larger parts or components different than described in any specific example herein. For purposes of clarity, the invention is described in terms of systems that include many different innovative components and innovative combinations of innovative components and known components. No inference should be taken to limit the invention to combinations containing all of the innovative components listed in any illustrative embodiment in this specification. The functional aspects of the invention, as will be understood from the teachings herein, may be implemented or accomplished using any appropriate implementation environment or programming language, such as C++, COBOL, Pascal, Java, Java-script, etc. All publications, patents, and patent applications cited herein are hereby incorporated by reference in their entirety for all purposes.

The invention therefore in specific aspects provides a streaming of continuous media such as video/audio signals that can be played on various types of video-capable terminal devices operating under any types of operating systems regardless of what type of players are pre-installed in the terminal devices. A number of suitable techniques are described in co-pending U.S. patent application Ser. N. 09/665,827, METHOD AND SYSTEM FOR PROVIDING WORLD WIDE STREAMING MEDIA SERVICES, by Horng-Juing Lee and Joe M-J Lin, filed on Sep. 20, 2000, and which is hereby incorporated by this reference.

In specific embodiments, the present invention involves methods and systems suitable for providing multimedia streaming over a communication data network including a cable network, a local area network, a network of other private networks and the Internet. Such methods and systems are described in copending U.S. patent applications Ser. Nos. 09/658,705, by Horng-Juing Lee, entitled “Method and Apparatus for Caching for Streaming Data”, filed on Sep. 8, 2000, U.S. patent application Ser. No. 09/668,498, entitled “Method and System for Providing Real-Time Streaming Video Services”, filed on Sep. 22, 2000, and U.S. patent application Ser. No. 09/679,763, entitled “Streaming Machine Aware Binary and Multimedia Content for Multimedia Synchronization”, filed on Oct. 5, 2000, which are hereby incorporated herein by this reference.

The present invention is presented largely in terms of procedures, steps, logic blocks, processing, and other symbolic representations that resemble data processing devices. These process descriptions and representations are the means used by those experienced or skilled in the art to most effectively convey the substance of their work to others skilled in the art. The method along with the system to be described in detail below is a self-consistent sequence of processes or steps leading to a desired result. These steps or processes are those requiring physical manipulations of physical quantities. Usually, though not necessarily, these quantities may take the form of electrical signals capable of being stored, transferred, combined, compared, displayed and otherwise manipulated in a computer system or electronic computing devices. It proves convenient at times, principally for reasons of common usage, to refer to these signals as bits, values, elements, symbols, operations, messages, terms, numbers, or the like. It should be borne in mind that all of these similar terms are to be associated with the appropriate physical quantities and are merely convenient labels applied to these quantities. Unless specifically stated otherwise as apparent from the following description, it is appreciated that throughout the present invention, discussions utilizing terms such as processing or computing or verifying or displaying or the like, refer to the actions and processes of a computing device that manipulates and transforms data represented as physical quantities within the device's registers and memories into analog output signals via resident transducers.

Sample Sequences for Streaming Multimedia Message

A few examples for the streaming of multimedia messages are now given, a first for creating and publishing streaming multimedia message and a second for browsing and rendering streaming multimedia message.

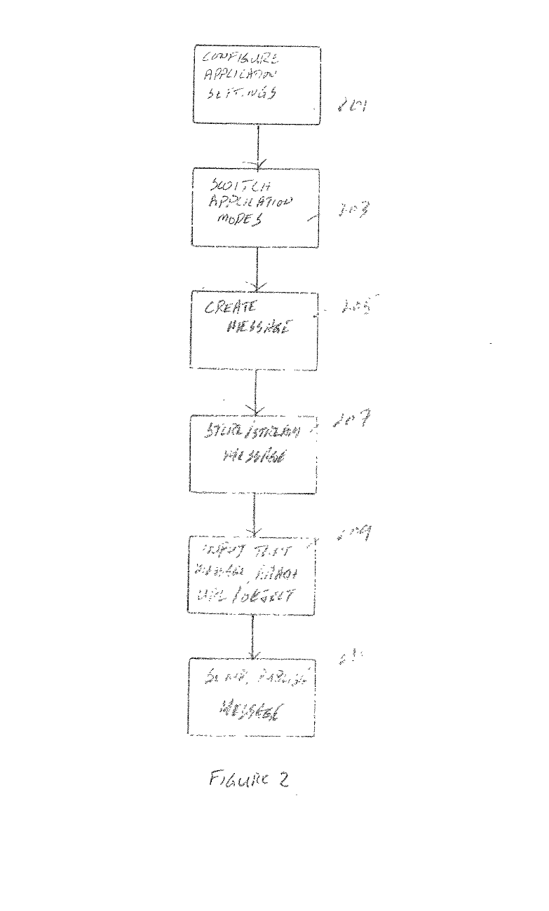

FIG. 2 is a flow chart for creating and publishing streaming a multimedia message. In step 201, the sender is provided with a set of guided control options, or “wizard”, to help configure the application settings for video mail, video phone, or other supported applications utilizing the designs Sender switches the application to the desirable mode of operation supported by the Navigation Control Manager in step 203. In video mail mode, in step 205 the sender creates a video/audio-enabled Internet e-mail message by sending a live source to the capture device first. The system uses Universal Audio/Video Capturing Manger to generate the video/audio stream.

In step 207, the sender uses the streaming media publishing manager to store video/audio data locally or concurrently stream the data to a streaming media server during creation. If it is stored locally, user has the option to stream it to a streaming media server later on using the manager. The user invokes the e-mail application through streaming media publishing manager to input the text message at 209. In the mean time, the manager attaches the URL to the video/audio, or the media object itself to the e-mail message. If user also sets the settings to publish the message, Streaming Media Publishing Manager would send the message as well as publish the message to a web server in step 211.

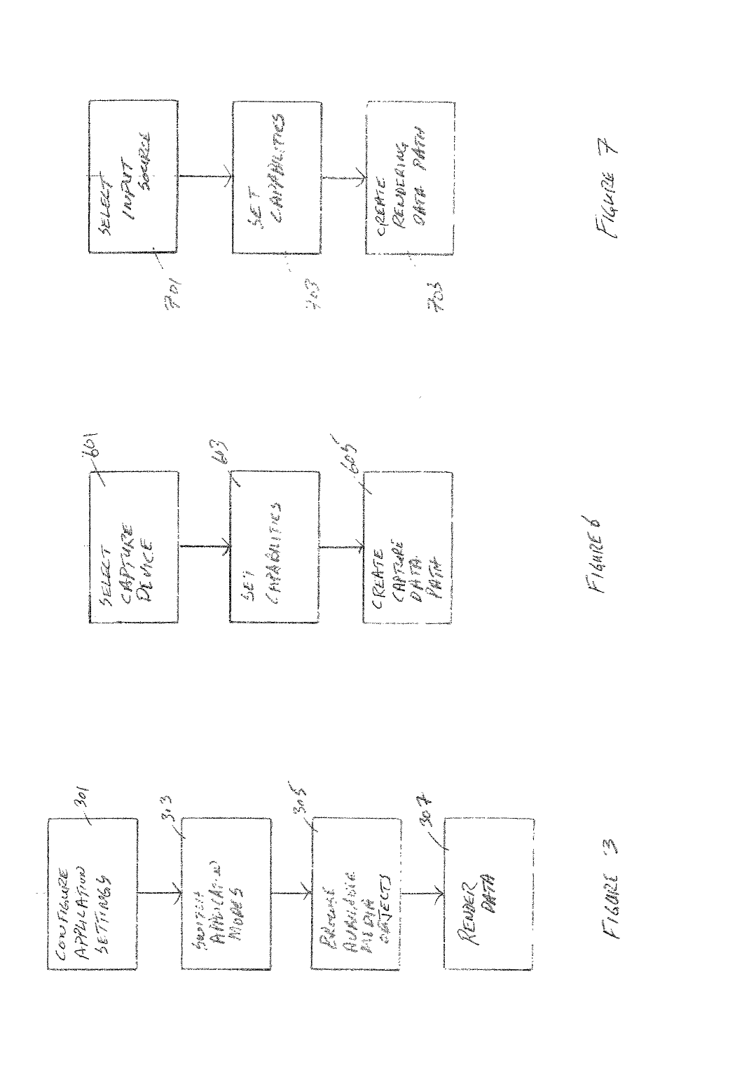

The second case of browsing and rendering streaming multimedia messages is shown in FIG. 3. Beginning at 301 a wizard helps the sender to configure the application settings for video mail, video phone, or other supported applications utilizing the designs The user switches the application to the desirable mode of operation supported by the navigation control manager at step 303. In video mail mode, in step 305 the user utilizes the Distributed Streaming Media Manager to browse the available media objects locally or on a streaming media server. If user selects and invokes a media object from streaming media server, universal audio/video rendering manager would render the data to the graphical or sound output devices at step 307.

Scalable Navigation Control Manager

The scalable navigation control manager contains in its core of two logical operations: “switch-on” and “switch-over”. “Switch-on” represents the runtime software system changing from the dormant state to the active state. In the dormant state, the system does not take any interactive input and waits for a “fire” signal. After receiving the “fire” signal, the system changes to the active state and expands its user interface to take user input. The system changes back from active state to dormant state when it receives a “quench” signal. The “switch-over” operation provides the switches from one functional feature to another when in the active state.

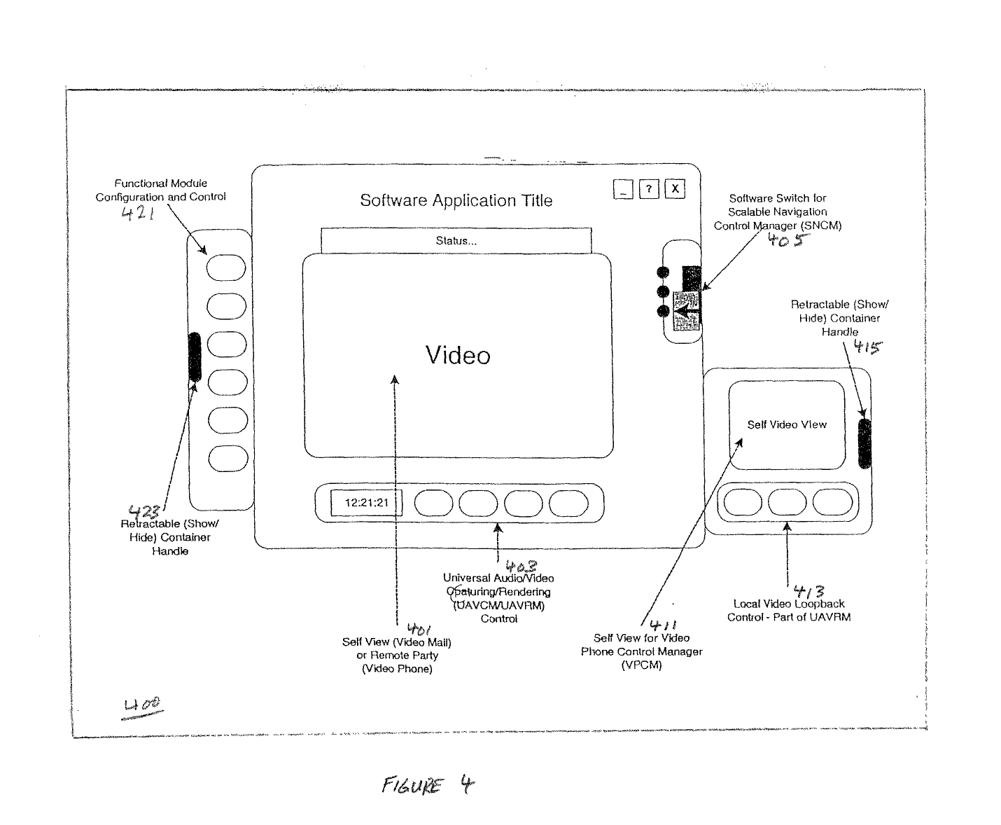

The building blocks of the manager are functional modules and the control logic. The control logic governs the sequence of “load” and “unload” operations, the pixel coordinates in the graphical display, and/or the explicitly mapped controls and inputs of the loaded modules. The control logic specification is a logical “AND” or “OR” list of subsystems to be enabled. For “AND” logic, those functions are coupled together to provide an integral service. For “OR” logic, those functions can coexist, but only one in functionality at a time. Each module is identified by a unique ID, which can be recognized at runtime on the computing device. Each functional module provides standard APIs to let callers to initialize (or un-initialize) the module, to get/set module capability, and to get/set module status. Typically, a module is initialized (or un-initialize) once it is loaded (or unloaded) into the runtime system. FIG. 4 depicts an application design using the manager and some other managers within the context.

This method enables electronic multimedia messaging on video/audio capture-equipped mobile platform with limited pre-installed software capability or memory footprint. For example, the receiver and sender may use different languages on their computers, with the sender employing, say, Japanese and the receiver working in English on a platform lacking the full software to receive in Japanese. In this method, the control logic can pick and choose the needed localized components that it loads onto the platform.

FIG. 4 shows an embodiment of an user interface design using the scalable navigation control manager and some other application modules on the display on a user's monitor 400. The central portion 401 shows the user's self view in the video mail mode or the remote party in the video phone mode.

Around this are various controls such as the universal audio/video capturing/rendering control 403 and the software switch for the scalable navigation control manager 405, which can be place at a convenient location on the periphery of the video 401. To the side of the central portion is self view for the video phone control manager 411, which can be retracted or expanded by the container handle 415 used to show or hide the self-view 411. Below this is the local video loopback control part 413 of the universal audio/video rendering control. Additionally, a functional module configuration and control 421 is shown which can be shown or hidden with the retractable container handle 423.

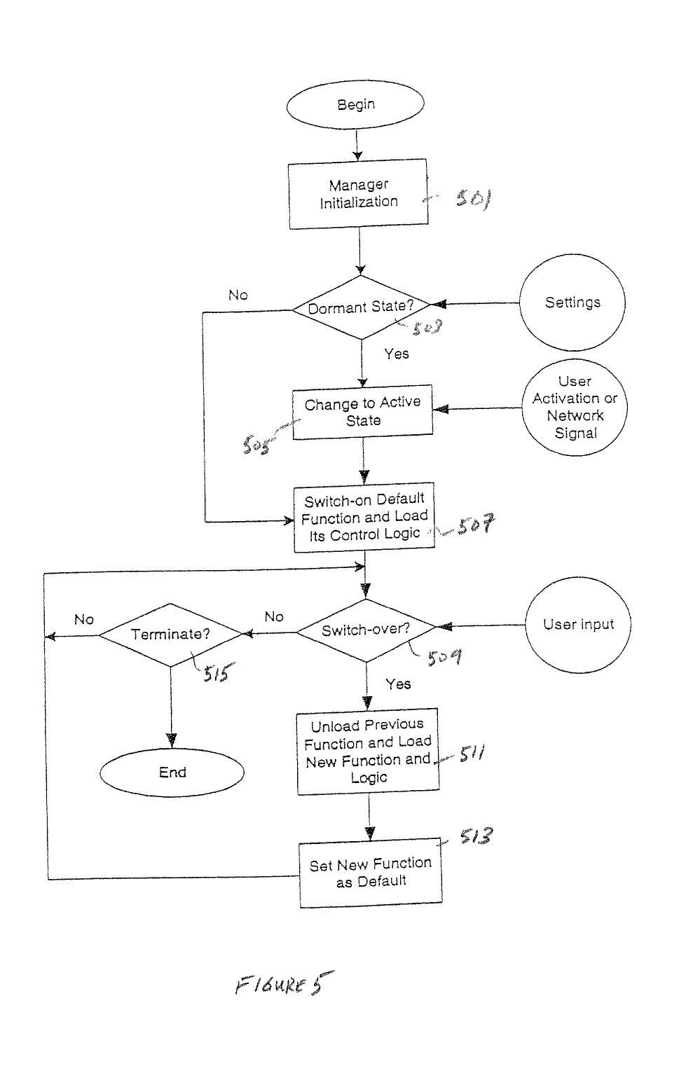

The procedures in an embodiment of the scalable navigation control manager are shown in FIG. 5. At step 501, the computing device loads the manager which is initialized by the launching application during startup time or through a user invocation. It will stay in dormant state unless it is explicitly configured to run in active state, in which case at step 503 the process jumps to step 507. If not explicitly configured to run in active state, the user brings up or expands the user interface of the manager, which then changes to active state at step 505. The firing signal may also come from a pre-existing network control connection.

The user interface provides a graphical representation of a switch in the graphical display. At step 507 a default function, such as the video phone, is switched on and its control logic is loaded. To “switch-over” to a desirable feature, the user input such as through a mouse or pointer device attached to the computing device to drag and move the switch to a labeled functional option in step 509. If the user indicates that a “switch over” is wanted, this triggers an “unload” operation in step 511 for a functional module that its feature is no longer needed for the subsequent operation. It then proceeds to a “load” operation to load a functional module corresponding to the feature at runtime. A functional module takes a control logic specification to set its initial capability in step 513 and the user operates on the user interface implicitly provided by the module or through a explicitly mapped user interface controls.

If the user does not receive a “switch-over” indication at step 509, it instead goes to step 515. If the manager receives a “quench” signal through user input, it un-initializes the loaded module and goes to dormant state, indicated by End. If it subsequently receives a “fire” signal, it repeats the procedures from step 503. From either step 513 or step 515 if there is no “quench” signal, the manager repeats steps 509 to 515 if it receives “switch-over” signal.

Procedures of Other Modules

Procedures of the other modules shown in the embodiment of FIG. 1 are now given, beginning with the universal audio/video capturing manager. The universal audio/video capturing manager handles continuous media capturing such as video and/or audio. It can be one of the functional modules exported to Navigation Control Manager or can be a subsystem embedded in some other modules. It provides separate lists for available video/audio input devices, compressors, and output sinks. It takes an “AND” logic for desirable combination of software representation of the components in one or more of the aforementioned lists.

The operating procedures are shown in FIG. 6 and are as follows. In step 601 the user selects desirable capture device. Optionally, the user can also select desirable compressors, and output sink. In step 603 the manager takes user's selections as input to set its capability or may alternately use the default capability. The manager creates a capture data path from capture device through compressors to output sink in step 605.

The universal audio/video rendering manager handles continuous media rendering, such as for video and/or audio. It can be one of the functional modules exported to navigation control manager or can be a subsystem embedded in other modules. It provides separate lists for available video/audio input source, decompressors, and output devices. It takes an “AND” logic for desirable combination of software representation of the components in one or more of the aforementioned lists.

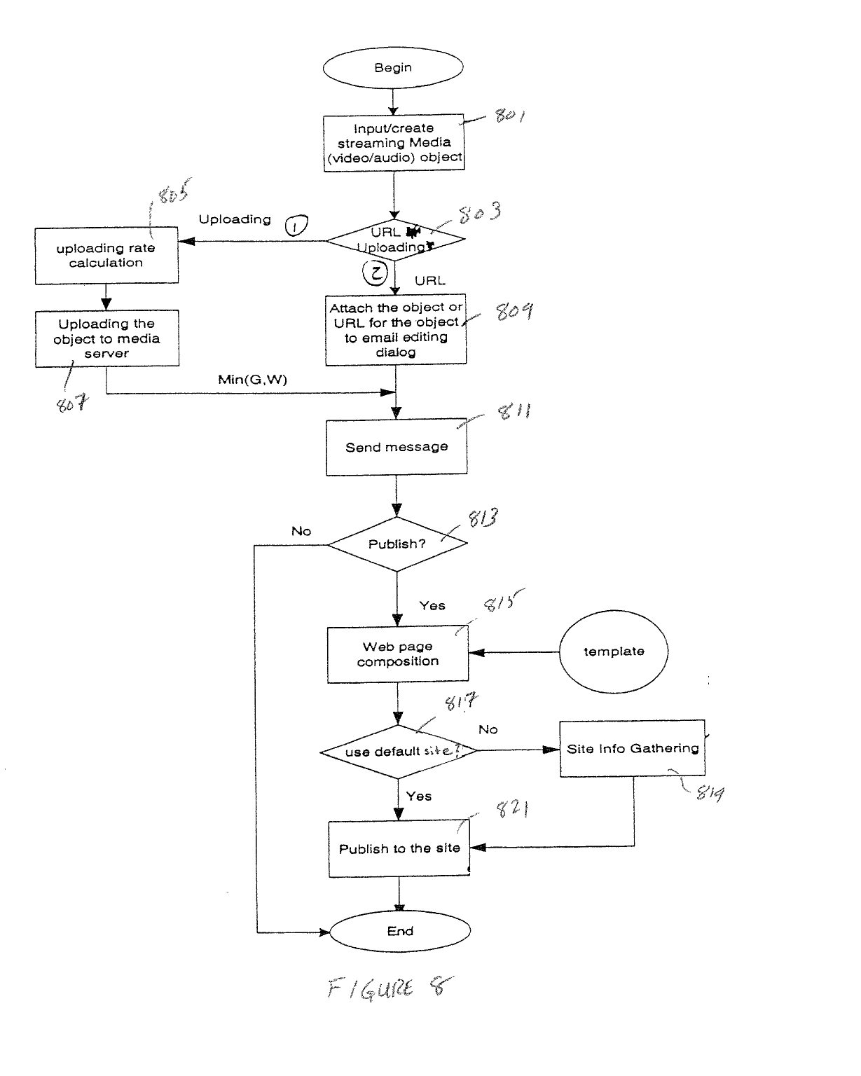

The operating procedures are shown in FIG. 7 and are as follows. In step 701 the user selects desirable input source. Optionally, the user can also select desirable decompressors and output devices. The manager takes user's selections as input at step 703 to set its capability, or may alternately use default capability The manager creates a rendering data path from input source through decompressors to output devices in step 705.

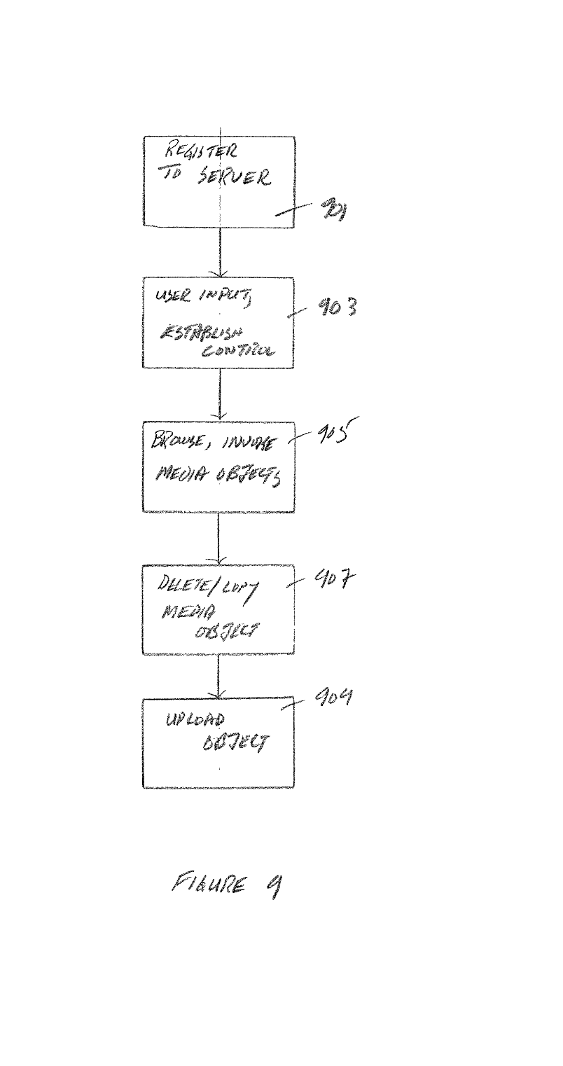

Streaming media publishing manager provides an integrated media stream uploading, e-mail messaging, and/or web publishing services through corresponding functional modules. The media stream uploading module utilizes an adaptive control scheme to upload the continuous media data over the network environment. The procedures to commence and finish the upload streaming are as follows. The flowchart is shown in FIG. 8.

In step 801, the continuous media content is created or input with the capturing module. At step 803, the process branches into a left path (1) and a right path (2). Paths (1) and (2) can be performed either serially or in parallel.

Beginning with the left path (1), step 805 is the uploading rate calculation. The module determines the available bandwidth to the streaming sources through round-trip statistics of contiguous Internet Control Message Protocol (ICMP) PING packets. The module uses the bandwidth statistics times a factor to be the Goodput (G), i.e., achievable streaming bandwidth. The factor is obtained through the estimation of application packet size over physical wire-transfer packet size. The module also retrieves a “Write-Penalty” (W), that is, the difference in time between writing and reading when uploading to the server, for streaming media server from the server. The minimum of G and W, i.e. MIN(G, W), is taken to be the upload streaming bandwidth. The module then makes connection to the server and sets information for the to-be-uploaded object.

The module sends the media object information to the server and then uploads the media object in step 807. If the uploading were not completed, the server would remove the partially loaded object.

The e-mail messaging module provides integral “search-and-locate” of e-mail applications on the computing device as well as a generic Internet e-mail subsystem which is independent of the other applications. The module searches and locates available e-mail applications on the computing device, and provides a list of available e-mail applications. The list can be retrieved by the get module capability API. The module determines the messaging API that the user-selected e-mail application supports, and loads the runtime library that implements the exported API. The module takes inputs of URL to the media object or the media object, and passes it onto the e-mail application as attachment in step 809. The module invokes the e-mail application's graphical user interface to take other user input.

The message is sent in step 811. The video, or other continuous media, message is sent to a location in a server, indicia of the location of the message, such as its URL, is attached to the electronic mail message and the electronic mail message is sent to the recipient along with the attached indicia. The sender simultaneously initiates sending the video message and sending the electronic mail message. Accordingly, the sender need not perform extra steps associated with sending both the e-mail message and the video message separately. In this way, sending of the video message to the server is essentially transparent to the user. In addition, the entire video message need not be sent through the electronic mail system, but only the indicia need be included with the e-mail message, thereby avoiding problems, such as stripping off of the attachment.

After sending the message in step 811, the unique Message ID in the Internet e-mail message is registered to the media object's metadata (description field) on the server. For e-mail application other than the generic one, the system ensures indempotent operation for deleted media objects and associated e-mail message. If a media object were deleted first, invocation of the playback in the corresponding e-mail message would return an error of “Object not found”. If the message were deleted first, the media object would stay on the server until its expiration time. This allows for a level of consistency and a “graceful degradation”.

In step 813 the web publishing module can be invoked. The web publishing module provides template-based web publishing capability. It takes the same inputs as the e-mail messaging module and posts them to a designated web site through standard web publishing protocol. A Data Type Definition (DTD) for web-based video messaging in W3C's XML format is defined to specify the template. The page is composed in step 815.

Step 815 begins with the module taking the DTD, a template, and user inputs. The module parses the template based on the DTD to determine the positions of the XML tags specified by the DTD and inserts user inputs to the corresponding XML tag enclosures. The module replaces XML tags by corresponding HTML tags and generates output of the web page in HTML format.

In step 817 the user can choose to either use a default site or specify an alternate site. If an alternate site is chosen, the user supplies the site information in step 819. In step 821 the page is published.

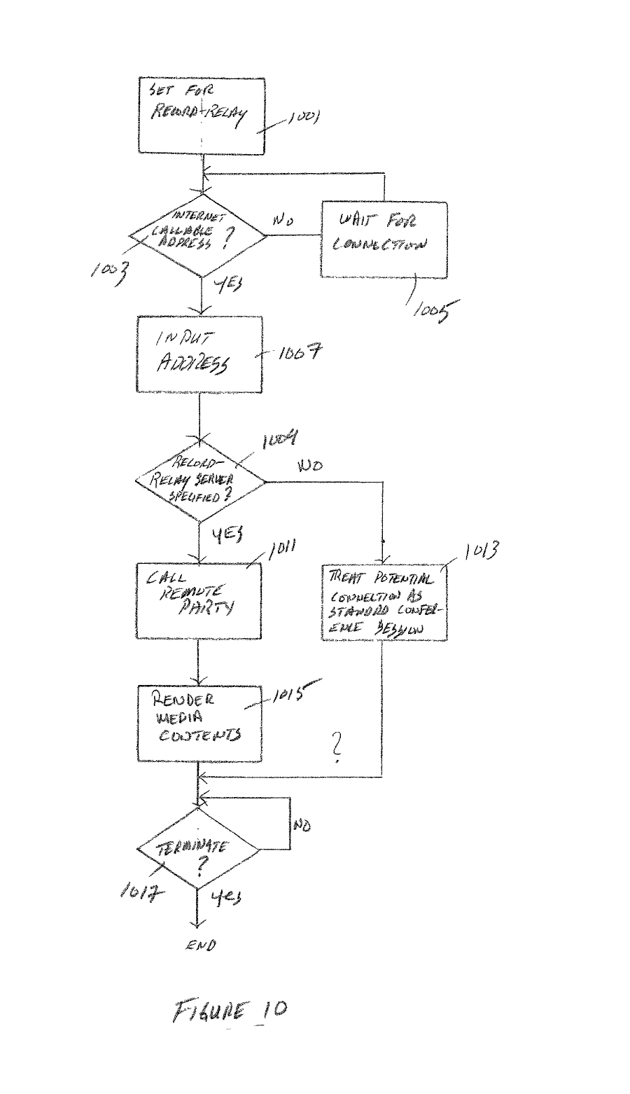

The distributed streaming media manager is a media-and-network-aware object management subsystem. It handles user administration, object creation/deletion, and information gathering for personal profile. The procedures are shown in FIG. 9.

The user registers to the streaming media server in step 901, where one or multiple directories dedicated for the user are created. A quota on the disk or other storage space can be enforced on the streaming media server. In step 903, the manager takes user name and password as input to get access permissions and rights for the user from the server, and to establish a control session to the server. The manager has API to browse the accessible media objects and invoke any of those objects for display or playback in step 905. In step 907 the manager has API to delete or copy a media object created by the Streaming Media Publishing Manager. The manager has API hook to the Streaming Media Publishing Manager to upload a continuous media object in step 909.

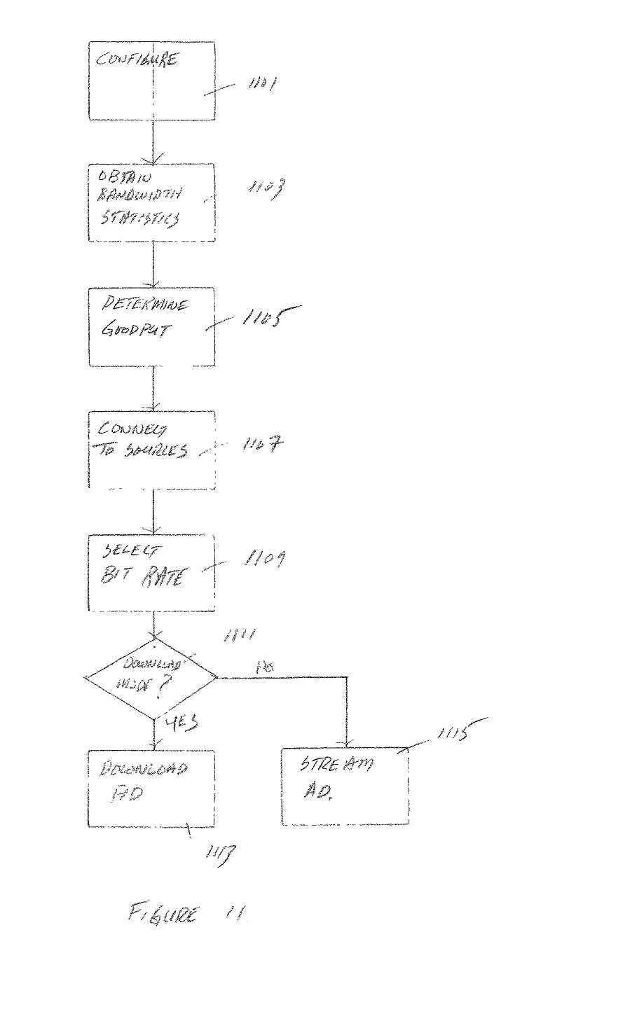

Video phone control manager provides both point-to-point video or audio conferencing as well as joining a multi-point conferencing recording session. Coupled with universal audio/video rendering manager, not only video phone control manager can handle real-time synchronous conferencing, but also asynchronous review of recorded conferencing session from either conference record-relay server or streaming media server. Techniques suitable for the real-time transmission of continuous media which could be used for synchronous conferencing are described in the U.S. patent application entitled “Method and System for Delivering Real Time Video and Audio” by Yen-Jen Lee, Chiun-An Chao, Lei Zheng, and Ming-Chao Chiang, which was filed concurrently with the present application, and which is hereby incorporated herein by this reference. The procedures for the video phone control manager are shown in FIG. 10.

Step 1001 is an optional step for the user to set the manager's capability for record-relay server address. The manager checks for the remote party's Internet callable address in step 1003, which is then input in step 1007. If there is no incoming connection, the manager waits in step 1005. Step 1009 checks for whether a record-relay server is specified. If so, the manager will call the remote party through the record-relay server in step 1011. If a record-relay server is not specified, in step 1013 the manager will treat potential connection as standard conferencing session. For a relay-record session, the manager utilizes the Universal Audio/Video Rendering Manager to render the media contents in step 1015. When the manager receives the disconnecting signal at step 1017, it terminates and removes the session.

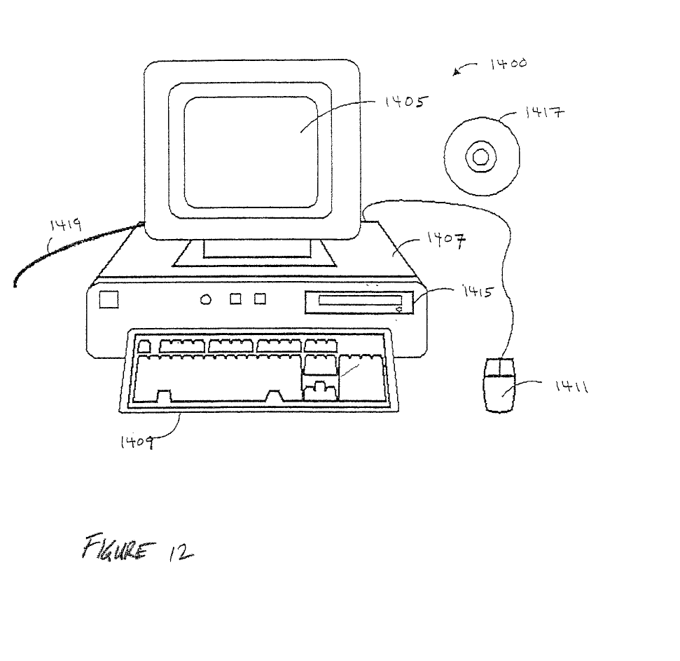

The last of the modules shown in the exemplary embodiment of FIG. 1 is the unattended streaming advertisement manager. This manager provides unmanned advertisements or other unrequested continuous media based on pre-configured settings or personal preference. It utilizes standard API design to get/set module capability for system idle time behavior. The settings are a list of preferred Internet streaming sources, such as IP addresses, domain names, or an implicit channel surfing guide, and the preferred display style, such as ad banner on the screen, screen saver, or both. FIG. 11 shows the procedures of one embodiment at runtime.

Referring to FIG. 11. In step 1101 the user configures the desirable application behavior, such as a screen saver, an ad banner, or both. The computing device loads the manager during application startup time if ad banner only feature is set. Alternately, the manager is loaded at system startup time.

When the system is idle (screen saver mode) or there is a designated display area (ad banner mode), the manager determines the available bandwidth to the streaming sources through round-trip statistics of contiguous Internet Control Message Protocol (ICMP) PING packets in step 1103. In step 1105 the manager uses the bandwidth statistics times a factor to be the Goodput (G), i.e., the achievable streaming bandwidth. The factor is obtained through a table of overhead estimation based on application packet size versus physical wire-transfer packet size.

The manager makes connection in step 1107 to a source at a time and gets information for default advertisement object. Step 1109 selects the bit rate. If multiple bit rates for the same advertisement are available, the manager uses a step-wise scheme to determine the floor (F) and ceiling (C) of each step. If the G is within a floor and ceiling, i.e. G∈[F, L], the manager picks the bit rate that matches the floor. If no floor is available to match the Goodput, the manager uses the clip with the lowest bit rate.

In order to provide smooth playback as much as possible, if the streaming bit rate from source to the computing device is less than, say, 80% of the Goodput and there is cache memory available on the computing device, the manager would switch from streaming to downloading mode. This is decided in step 1111, and the advertisements are either downloaded, step 1113, or streamed, step 1115, accordingly. In this manner, if there is insufficient bandwidth for streaming, it can download part of the data, play it back, download more, and so on, where the buffering can take place during the playback. In the interim session, the manager would render and display a default media object on the local permanent memory or an alternative ad flyer from remote or local. After the downloading is completed, the manager would switch the display to the downloaded media object.

Application Domains

As already noted, the described structures and methods are suitable for continuous media besides video related service, and deliverable over both the Internet, Intranet, and other network environments. This includes (but not limit to) video on demand service, video mail service, movie on demand service, etc.

Additionally, although this discussion has focused on streaming continuous media, these techniques extend to the non-continuous data. This is particularly so where the amount of data being transmitted for a single media data title is, although not continuous, very large. An example is the transmission of an image, for example a high-resolution X-ray. Here the amount of data may be of sufficient size that it is more practical to transmit the particular media data title broken up into blocks as is done for the continuous case. The limits on transmitting this data then become the same as for the continuous case, with similar storage and transmission bandwidth concerns.

The media delivery system as described herein is robust, operationally efficient and cost-effective. In addition, the present invention may be used in connection with presentations of any type, including sales presentations and product/service promotion, which provides the video service providers additional revenue resources.

The processes, sequences or steps and features discussed herein are related to each other and each are believed independently novel in the art. The disclosed processes and sequences may be performed alone or in any combination to provide a novel and nonobvious file structure system suitable for media delivery system. It should be understood that the processes and sequences in combination yield an equally independently novel combination as well, even if combined in their broadest sense.

Other Embodiments

The invention has now been described with reference to specific embodiments. Other embodiments will be apparent to those of skill in the art.

In particular, a user digital information appliance has generally been illustrated as a personal computer. However, the digital computing device is meant to be any device for interacting with a remote data application, and could include such devices as a digitally enabled television, cell phone, personal digital assistant, etc.

Furthermore, while the invention has in some instances been described in terms of client/server application environments, this is not intended to limit the invention to only those logic environments described as client/server. As used herein, client is intended to be understood broadly to comprise any logic used to access data from a remote system and server is intended to be understood broadly to comprise any logic used to provide data to a remote system.

It is understood that the examples and embodiments described herein are for illustrative purposes only and that various modifications or changes in light thereof will be suggested by the teachings herein to persons skilled in the art and are to be included within the spirit and purview of this application and scope of the claims and their equivalents.

Embodiment in a Programmed Information Appliance

As shown in FIG. 12, the invention can be implemented in hardware and/or software. In some embodiments of the invention, different aspects of the invention can be implemented in either client-side logic or a server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media program may be delivered to a user on a fixed media for loading in a users computer or a fixed media program can reside on a remote server that a user accesses through a communication medium in order to download a program component.

FIG. 12 shows an information appliance (or digital device) 1400 that may be understood as a logical apparatus that can read instructions from media 1417 and/or network port 1419. Apparatus 1400 can thereafter use those instructions to direct server or client logic, as understood in the art, to embody aspects of the invention. One type of logical apparatus that may embody the invention is a computer system as illustrated in 1400, containing CPU 1407, optional input devices 1409 and 1411, disk drives 1415 and optional monitor 1405. Fixed media 1417 may be used to program such a system and may represent a disk-type optical or magnetic media, magnetic tape, solid state memory, etc. The invention may be embodied in whole or in part as software recorded on this fixed media. Communication port 1419 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language which may be used to create an ASIC or PLD that operates as herein described.

What is claimed is:

1. A method allowing transfer of an addressed message with associated continuous media content from a sender to a receiver, comprising:
accepting, from the sender, the associated continuous media at a server;
storing the associated continuous media at the server;
providing a reference of said stored associated continuous media content for inclusion in said addressed message;
sending the addressed message from the sender to the receiver;
registering a request from said receiver to access said stored associated continuous media content; and
streaming said stored associated continuous media content to said receiver.

2. The method according to claim 1, further comprising:
publishing said stored associated continuous media content as a web page.

3. The method according to claim 1 wherein said accepting comprises receiving prerecorded continuous media content from said sender.

4. The method according to claim 1 wherein said accepting comprises receiving streaming content from said sender.

5. The method according to claim 1 wherein said streaming further comprises:
determining a desirable format for transmitting said stored associated continuous media content to the receiver; and
streaming said stored associated continuous media content to said receiver in said desired format.

6. The method according to claim 5 wherein said determining comprises:
detecting from said request a presentation device of said receiver.

7. The method according to claim 5 wherein said determining comprises:
determining an available bandwidth for transmitting to said receiver.

8. The method according to claim 1 further comprising:
receiving at said server an indication from said receiver to delete said stored associated continuous media content message without delivering said stored associated continuous media content.

9. The method according to claim 1 further comprising:
receiving at said server an indication from said sender to delete said stored associated continuous media content without delivering said stored associated continuous media content.

10. The method according to claim 1, further comprising:
at said server, establishing an expiration time for said stored associated continuous media content; and
deleting said stored associated continuous media content after the expiration of said expiration time.

11. The method according to claim 10, further comprising:
prior to deleting said stored associated continuous media content, forwarding a non-streamed version of said stored content to said receiver.

12. The method according to claim 10, further comprising:
upon expiration of said stored associated continuous media content, sending a deletion notice to said sender.

13. The method according to claim 10, further comprising:
upon expiration of said stored associated continuous media content, sending a deletion notice to said receiver.

14. The method according to claim 1, wherein said method enables messaging between senders and receivers with limited pre-installed messaging hardware.

15. The method according to claim 1 further comprising:
determining when a receiving system is idle; and
transmitting an unrequested continuous media message when said receiving system is idle.

16. A method allowing a user to create and publish a multimedia message comprising:
providing a set of guided control options allowing a user to configure settings for one or more of a plurality of supported applications;
allowing a user to indicate a desired application; and
utilizing said desired application for a process comprising:
capturing of a multimedia message from the user;
storing said multimedia message;
allowing the user to enter e-mail text to create a text portion of the message; and
attaching an access for said multimedia message to said e-mail text.

17. The method of claim 16, wherein said plurality of supported applications include video mail and video phone.

18. The method according to claim 16, wherein said storing comprises locally storing multimedia content.

19. The method according to claim 16, wherein said storing comprises streaming said multimedia content to a remote server for storage.

20. The method according to claim 16, further comprising:
providing a screen saver mode that accepts transmission of unrequested continuous media when a system is idle for a predetermined period of time.

21. The method according to claim 16 further comprising:
publishing said multimedia content to a web server.

22. A method allowing a user to access multimedia messages comprising:
providing a set of guided control options allowing a user to configure settings for one or more of a plurality of supported applications;
allowing the user to indicate a desired application;
utilizing said desired application for a process comprising:
providing an interface allowing a user to available media objects browse with the desired application; and
using a universal audio/video rendering manager to render the data to one or more of a plurality of output devices.

23. The method of claim 22, wherein said plurality of supported applications include video mail and video phone.

24. The method of claim 22, wherein said plurality of output devices include graphical and sound output devices.

25. The method according to claim 22 wherein one or more of said available media objects are stored on a remote server.

26. The method according to claim 25 wherein a request to access one of said remotely stored media object is automatically generated when the user opens an e-mail.

27. The method according to claim 22, wherein said interface is a standard e-mail access interface and a request to access a remote streaming media object is automatically generated when the user opens an e-mail.

28. The method according to claim 22, further comprising:
when a receiving system is idle, accepting transmission of unrequested continuous media messages at the system.

29. The method according to claim 22, further comprising:
providing a screen saver mode that accepts transmission of unrequested continuous media at a system when the system is idle for a predetermined period of time.

30. A modular software system for video messaging wherein invocation of appropriate modules allows the system to perform a variety of video messaging functions comprising:
a scalable navigation control manager; and
one or more functional modules, each performing separable messaging functions.

31. The system of claim 30, wherein said one or more function modules are selected from the group consisting of:
a capturing manager;
a rendering manager;
a streaming publishing manager;
a distributed streaming media manager;
a video phone control manager; and
an unattended streaming advertisement manager.

32. The system of claim 30, wherein said one or more function modules provide the functions of:
originating and sending a video message;
browsing and viewing a stored video message;
publishing a message including video content; and
conducting a two way video conference.

33. The system of claim 30, wherein said scalable navigation control manager includes control logic for interfacing with any of said additional modules.

34. The system of claim 30, wherein said scalable navigation control manager is able to interface with one or more presentation devices.

35. The system of claim 34, wherein said presentation devices include a video phone.

36. The system of claim 34, wherein said presentation devices include video email.

37. The system of claim 34, wherein said presentation devices include internet TV.

38. A method of operation of a streaming publishing manager comprising:
determining available bandwidth to streaming sources via measurement of round-trip statistics and from available bandwidth determining an achievable streaming bandwidth;
determining a write-penalty for a server;
selecting a minimum of achievable streaming bandwidth and write-penalty to be the upload streaming bandwidth;
connecting to a server and setting information for to-be-uploaded object;
sending object information to said server; and
uploading media object.

39. A computer readable storage device embodying a program of instructions executable by a computer to perform a method allowing transfer of an addressed message with associated continuous media content from a sender to a receiver, said method comprising:
accepting, from the sender, the associated continuous media at a server;
storing the associated continuous media at the server;
providing a reference of said stored associated continuous media content for inclusion in the addressed message;
sending the addressed message from the sender to the receiver;
registering a request from said receiver to access said stored associated continuous media content; and
streaming said stored associated continuous media content to said receiver.

40. The method according to claim 39, further comprising:
publishing said stored associated continuous media content as a web page.

41. The method according to claim 39 wherein said streaming further comprises:
determining a desirable format for transmitting said stored associated continuous media content to the receiver; and
streaming said stored associated continuous media content to said receiver in said desired format.

42. The method according to claim 39, wherein said method enables messaging between senders and receivers with limited pre-installed messaging hardware.

43. A method for transmitting a program of instructions executable by a computer to perform a process allowing transfer of an addressed message with associated continuous media content from a sender to a receiver, said method comprising:
causing the transmission to a client device a program of instructions, thereby enabling the client device to perform, by means of such program, the following process:
accepting, from the sender, the associated continuous media at a server;
storing the associated continuous media at the server;
providing a reference of said stored associated continuous media content for inclusion in the addressed message;
sending the addressed message from the sender to the receiver;
registering a request from said receiver to access said stored associated continuous media content; and
streaming said stored associated continuous media content to said receiver.

44. The process according to claim 43, further comprising:
publishing said stored associated continuous media content as a web page.

45. The process according to claim 43, wherein said streaming further comprises:
determining a desirable format for transmitting said stored associated continuous media content to the receiver; and
streaming said stored associated continuous media content to said receiver in said desired format.

46. The process according to claim 43, wherein said method enables messaging between senders and receivers with limited pre-installed messaging hardware.

47. A computer readable storage device embodying a program of instructions executable by a computer to perform a method allowing a user to create and publish a multimedia message, said method comprising:
providing a set of guided control options allowing a user to configure settings for one or more of a plurality of supported applications;
allowing a user to indicate a desired application; and
utilizing said desired application for a process comprising:
capturing of a multimedia message from the user;
storing said multimedia message;
allowing the user to enter e-mail text to create a text portion of the message; and
attaching an access for said multimedia message to said e-mail text.

48. The method of claim 47, wherein said plurality of supported applications include video mail and video phone.

49. The method according to claim 47, further comprising:
publishing said multimedia content to a web server.

50. A method for transmitting a program of instructions executable by a computer to perform a process method allowing a user to create and publish a multimedia message, said method comprising:
causing the transmission to a client device a program of instructions, thereby enabling the client device to perform, by means of such program, the following process:
providing a set of guided control options allowing a user to configure settings for one or more of a plurality of supported applications;
allowing a user to indicate a desired application; and
utilizing said desired application for a process comprising:
capturing of a multimedia message from the user;
storing said multimedia message;
allowing the user to enter e-mail text to create a text portion of the message; and
attaching an access for said multimedia message to said e-mail text.

51. The process of claim 50, wherein said plurality of supported applications include video mail and video phone.

52. The process according to claim 50 further comprising:
publishing said multimedia content to a web server.

53. A computer readable storage device embodying a program of instructions executable by a computer to perform a method allowing a user to access multimedia messages, said method comprising:
providing a set of guided control options allowing a user to configure settings for one or more of a plurality of supported applications;
allowing the user to indicate a desired application;
utilizing said desired application for a process comprising:
providing an interface allowing a user to available media objects browse with the desired application; and
using a universal audio/video rendering manager to render the data to one or more of a plurality of output devices.

54. The method according to claim 53 wherein one or more of said available media objects are stored on a remote server.

55. he method according to claim 53, wherein said interface is a standard e-mail access interface and a request to access a remote streaming media object is automatically generated when the user opens an e-mail.

56. A method for transmitting a program of instructions executable by a computer to perform a process method allowing a user to access multimedia messages, said method comprising:
causing the transmission to a client device a program of instructions, thereby enabling the client device to perform, by means of such program, the following process:
providing a set of guided control options allowing a user to configure settings for one or more of a plurality of supported applications;
allowing the user to indicate a desired application;
utilizing said desired application for a process comprising:
providing an interface allowing a user to available media objects browse with the desired application; and
using a universal audio/video rendering manager to render the data to one or more of a plurality of output devices.

57. The method according to claim 56, wherein one or more of said available media objects are stored on a remote server.

58. The method according to claim 56, wherein said interface is a standard e-mail access interface and a request to access a remote streaming media object is automatically generated when the user opens an e-mail.
